(19) United States
(12) Patent Application Publication
(10) Pub. No.: US 2004/0175493 A1
(43) Pub. Date: Sep. 9, 2004

(54) Producing a stripee-shaped application of a substrate, in particular of on adhesive, on a backing material

(75) Inventors: Thomas Monschein, Durbach (DE); Johannes Kiefer, Eckartsweier (DE); Michael Rossler, Willstatt (DE); Werner Blum, Hohberg-Diersburg (DE)

Correspondence Address: Norris, McLaughlin & Marcus P.A., 30th Floor, 220 East 42nd Street, New York, NY, 10017, US

(73) Assignee: Tesa, Hamburg (DE)

(21) Appl. No.: 10/628,786

(22) Filed: Jul. 28, 2003

(30) Foreign Application Priority Data
Mar. 5, 2003 (DE) 103 09 447.4

(51) Int. Cl. B05D 5/10

(52) U.S. Cl. 427/207.1; 427/428.1; 427/286

(57) ABSTRACT

A process for producing an adhesive tape with a stripe-shaped application of the adhesive on a backing material, where the backing web is guided past a dip roll which is in contact with the backing web, the roll rotates in a bath of adhesive, thereby transferring the adhesive to the roll surface, the roll is designed such that after the roll has run through the bath at least one stripe on the roll surface is adhesive-free.

The invention pertains to a process for producing a stripe-shaped application of a substrate, in particular of an adhesive, on a backing material.

Normally adhesive tapes are produced by applying an adhesive coating to the full area of one or both sides of a backing material. Depending on the process, application is followed by drying.

Subsequently the coated backing material is rolled up to form a “jumbo” or stock roll, from which individual known adhesive tape rolls are then slit.

Depending on backing material, adhesive, and in-process treatment such as, for example, irradiation with UV light, bombardment with electrons, or vulcanization, adhesive tapes are produced which have a different profile of adhesive properties such as, for example, bond strength to steel, bond strength to the reverse, tack, shear stability, unwind force, adhesion at elevated temperatures.

A problem is the rapid and inexpensive production of an adhesive tape which has one or more longitudinal stripes of adhesive on the backing material.

The present invention is based on the object of providing a process which allows the particularly simple, inexpensive, and rapid production of a stripe-shaped application of a substrate, in particular of an adhesive, on a backing material, so that the disadvantages of the prior art occur, if at all, then at least not to the same extent.

This object is achieved by a process as set down in the main claim. The subclaims relate to advantageous developments of the process and to an adhesive tape produced by the process of the invention.

The invention accordingly provides a process for producing a stripe-shaped application of a substrate, in particular of an adhesive, on a backing material, where

the backing web is guided past a dip roll which is in contact with the backing web,

the roll rotates in a bath of a substrate, in particular adhesive, thereby transferring the substrate to the roll surface,

the roll is designed such that after the roll has run through the bath at least one stripe on the roll surface is substrate-free.

In a first preferred embodiment of the invention the roll surface is completely smooth, without grooves and/or depressions, and additionally the surface can be coated, with chrome or hard material, to prolong its life.

In another preferred embodiment of the invention the roll surface in the regions in which no substrate, in particular adhesive, is to be transferred to the backing material bears grooves, or these regions have been rendered dehesive, so that on rotation the roll at these points does not pick up any substrate.

With further preference there is located between bath and backing material downstream of the roll in the direction of rotation a comb-shaped stripper of metal or plastic whose teeth remove the substrate or adhesive in stripe form from the surface of the roll.

It has been found advantageous if the roll rotates in the web direction.

It is further advantageous if a doctor blade is present downstream of the roll in the web direction.

In the coating operation of the invention with a doctor blade applicator unit the adhesive is transferred in excess to the material web by means of the (dip) roller, which rotates in particular in the web direction. In order to set a defined adhesive application rate, a slow-turning doctor blade strips away the adhesive down to a defined residual level.

Preference is given to using a wire doctor blade, composed of a circular rod around which a wire is wrapped. It is also advantageous to use a circular rod which can either have grooved profiling, so that the circular rod looks similar to a threaded rod, or smooth, i.e., without profile. In the case of the grooved profile a groove is made in spiral form: the breadth and depth and pitch of the groove define the quantity of material applied. The elevations alongside the groove can either run to a point or be rounded off. The circular rod may also have a partly grooved profile.

In order to prevent dry running of the doctor blade on the substrate-free or adhesive-free areas it is possible to mill a channel into the doctor blade bed (part in which the doctor blade is mounted) and into this channel to introduce substrate or adhesive in order to wet the doctor blade completely with substrate or adhesive over the entire web width.

In order to obtain an exact width of the preferred adhesive stripes on the material web it is possible to make the following modifications to the process of the invention:

the direction of rotation of the dip roll can be adjusted with respect to the web direction. In this way always the complete amount of the adhesive present on the dip roll is transferred to the material web.

a doctor blade can be used which in the adhesive-free areas does not possess a grooved profile or the groove profile is closed.

the depth and the width of the teeth of the stripper are adjustable, so that the amount of adhesive on the dip roll can be adjusted.

the dip roll speed can be adjusted in accordance with the desired application rate of the preferred adhesive.

As the substrate which is to be coated onto the backing material use is made in particular of primers, varnishes, and emulsion paints, and very particularly of the more frequently mentioned adhesive.

Further embraced by the concept of the invention is an adhesive tape obtained by the process of the invention, to the adhesive having been applied in the longitudinal direction at least one side of the backing material of the adhesive tape, in the form of a stripe having lower width than the backing material of the adhesive tape.

In a further advantageous embodiment the adhesive tape is coated from both sides of the backing with adhesive, with coating taking place in each case only on part of the backing. The coatings of the two different sides are applied in particular with an offset, in other words, on one side of the backing the coating is on the right-hand edge while on the opposite side the adhesive is on the left-hand edge.

It is also possible to configure one of the two coatings as a full-area coating.

In one preferred version only a single stripe is present on the backing material. In a further advantageous embodiment this coated stripe has a width of from 10 to 80% of the width of the backing material, chosen specifically as a function of the application. With particular preference stripes with a coating of from 20 to 50% of the width of the backing material are employed.

Depending on the particular utility it is also possible to coat two or more parallel stripees of the substrate or adhesive on the backing material.

As backing or carrier material for the preferred adhesive tape it is possible to use all known textile carriers such as wovens, knits or nonwoven webs; the term “web”embraces at least textile sheetlike structures in accordance with EN 29092 (1988) and also stitchbonded nonwovens and similar systems.

It is likewise possible to use spacer fabrics, including wovens and knits, with lamination. Spacer fabrics of this kind are disclosed in EP 0 071 212 B1. Spacer fabrics are matlike layer structures comprising a cover layer of a fiber or filament fleece, an underlayer and individual retaining fibers or bundles of such fibers between these layers, said fibers being distributed over the area of the layer structure, being needled through the particle layer, and joining the cover layer and the underlayer to one another. As an additional though not mandatory feature, the retaining fibers in accordance with EP 0 071 212 B1 comprise inert mineral particles, such as sand, gravel or the like, for example. The holding fibers needled through the particle layer hold the cover layer and the underlayer at a distance from one another and are joined to the cover layer and the underlayer.

Spacer wovens or spacer knits are described, inter alia, in two articles, namely

an article from the journal kettenwirk-praxis 3/93, 1993, pages 59 to 63, “Raschelgewirkte Abstandsgewirke” [Raschel-knitted spacer knits] and

an article from the journal kettenwirk-praxis 1/94, 1994, pages 73 to 76, “Raschelgewirkte Abstandsgewirke”,

the content of said articles being included here by reference and being part of this disclosure and invention.

Suitable nonwovens include, in particular, consolidated staple fiber webs, but also filament webs, meltblown webs, and spunbonded webs, which generally require additional consolidation. Known possible consolidation methods for webs are mechanical, thermal, and chemical consolidation. Whereas with mechanical consolidations the fibers are held together purely mechanically by entanglement of the individual fibers, by the interlooping of fiber bundles or by the stitching-in of additional threads, it is possible by thermal and by chemical techniques to obtain adhesive (with binder) or cohesive (binderless) fiber-fiber bonds. Given appropriate formulation and an appropriate process regime, these bonds may be restricted exclusively, or at least predominantly, to the fiber nodal points, so that a stable, three-dimensional network is formed while retaining the loose, open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Meyer, formerly Malimo, and can be obtained, inter alia, from the companies Naue Fasertechnik and Techtex GmbH. A Malifleece is characterized in that a cross-laid web is consolidated by the formation of loops from fibers of the web.

The carrier used may also be a web of the Kunit or Multiknit type. A Kunit web is characterized in that it originates from the processing of a longitudinally oriented fiber web to form a sheetlike structure which has the heads and legs of loops on one side and, on the other, loop feet or pile fiber folds, but possesses neither threads nor prefabricated sheetlike structures. A web of this kind has been produced for many years, for example on stitchbonding machines of the “Kunitvlies” type from the company Karl Mayer. A further characterizing feature of this web is that, as a longitudinal-fiber web, it is able to absorb high tensile forces in the longitudinal direction. The characteristic feature of a Multiknit web relative to the Kunit is that the web is consolidated on both the top and bottom sides by virtue of the double-sided needle punching.

Finally, stitchbonded webs are also suitable as an intermediate forming an adhesive tape of the invention. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

Also particularly advantageous is a staple fiber web which is mechanically preconsolidated in the first step or is a wet-laid web laid hydrodynamically, in which between 2% and 50% of the web fibers are fusible fibers, in particular between 5% and 40% of the fibers of the web.

A web of this kind is characterized in that the fibers are laid wet or, for example, a staple fiber web is preconsolidated by the formation of loops from fibers of the web or by needling, stitching or air-jet and/or water-jet treatment.

In a second step, thermofixing takes place, with the strength of the web being increased again by the (partial) melting of the fusible fibers.

The web carrier may also be consolidated without binders, by means for example of hot embossing with structured rollers, with properties such as strength, thickness, density, flexibility, and the like being controllable via the pressure, temperature, residence time, and embossing geometry.

For the inventive use of nonwovens, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in; as a sheet or as a mesh, or in the form of binding fibers. Liquid binders may be applied as solutions in water or organic solvent or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe “(Georg Thieme Verlag, Stuttgart, 1982) or “Textiltechnik-Vliesstofferzegung”(Arbeitgeberkreis Gesamttextil, Eschborn, 1996).

For mechanically preconsolidated webs which already possess sufficient composite strength, the single-sided spray application of a binder is appropriate for effecting specific changes in the surface properties.

Such a procedure is not only sparing in its use of binder but also greatly reduces the energy requirement for drying. Since no squeeze rollers are required and the dispersion remains predominantly in the upper region of the web material, unwanted hardening and stiffening of the web can very largely be avoided.

For sufficient adhesive consolidation of the web carrier, the addition of binder in the order of magnitude of from 1% to 50%, in particular from 3% to 20%, based on the weight of fiber web, is generally required.

The binder may be added as early as during the manufacture of the web, in the course of mechanical preconsolidation, or else in a separate process step, which may be carried out in-line or off-line. Following the addition of the binder it is necessary temporarily to generate a condition in which the binder becomes adhesive and adhesively connects the fibers —this may be achieved during the drying, for example, of dispersions, or else by heating, with further possibilities for variation existing by way of ariel or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process. It is advantageous that, as a result of the thermal treatment, volatile components such as fiber assistants are removed, giving a web having favorable fogging values so that when a low-fogging adhesive is used it is possible to produce an adhesive tape having particularly advantageous fogging values.

A further, special form of adhesive consolidation consists in activating the binder by incipient dissolution or swelling. In this case it is also possible in principle for the fibers themselves, or admixed special fibers, to take over the function of the binder. Since, however, such solvents are objectionable on environmental grounds, and/or are problematic in their handling, for the majority of polymeric fibers, this process is not often employed.

Starting materials envisaged for the textile carrier include, in particular, polyester, polypropylene, viscose or cotton fibers. The present invention is, however, not restricted to said materials; rather it is possible to use a large number of other fibers to produce the web, this being evident to the skilled worker without any need for inventive activity.

Also suitable is a backing material which is composed of a laminate, of a film (for example, PP, PE, PET, PA, PVC), of metal foil, or foam or of a foamed foil. Also suitable is a backing material made of creped or uncreped paper or else of paper with or without impregnation and/or coating in various thicknesses.

Low flammability in the adhesive tapes may be achieved by adding flame retardants to the (nonwoven) backing and/or to the preferred adhesive. These retardants may be organobromine compounds, together where appropriate with synergists such as antimony trioxide; however, with a view to the absence of halogens from the adhesive tape, preference will be given to using red phosphorus, organophosphorus compounds, mineral compounds or intumescent compounds such as ammonium polyphosphate, alone or in conjunction with synergists.

For producing an adhesive tape, the backing material is coated in particular on one side in the longitudinal direction with a stripe of substrate, in particular adhesive; the adhesives are in accordance with the state of the art.

As adhesives it is possible in principle to choose various polymer systems, with natural rubber systems or synthetic rubber systems and also acrylate systems having been found advantageous in particular; silicone adhesives and other known self-adhesive compositions can likewise be employed for applications of this kind, provided their adhesive properties, temperature stabilities, and compactibilities with the medium to which sticking is to take place are in accordance with the requirements.

As adhesives it is possible to use substantially all known adhesives possessing low viscosity. Particular preference is given to using adhesives having a viscosity <2000 mpa*s. In the case of other substrates such as primers, varnishes, and emulsion paints it is likewise preferred to use a viscosity <2000 mpa*s.

The adhesive of the adhesive tape preferred in accordance with the invention may be composed of an adhesive based on solventborne natural rubber adhesives, synthetic rubber adhesives, and acrylic adhesives. Preference is given to aqueous adhesives based on acrylate and also based on polyvinyl acetate, polyvinyl acetate-ethylene copolymers, neoprene, styrene-butadiene, natural rubber latex, polyurethane, polyvinyl alcohol. These adhesive technologies are widespread in the adhesive tape industry.

The quantity of adhesive applied to the backing material is preferably from 1 to 80 g/m² . In a further preferred embodiment the coatweight set is from 10 to 40 g/m².

Besides water use is also made preferably of commercially customary solvents, in particular low-boiling hydrocarbons, ketones, alcohols and/or esters.

The solution of the adhesive can contain from 5 to 80% by weight, in particular from 30 to 70% by weight, of solvent.

The residual solvent content ought to be below 1% by weight. The solution of the adhesive can contain from 5 to 80% by weight, in particular from 30 to 70% by weight, of water.

The residual water content ought to be below 1% by weight.

Particularly advantageous for the concept of the invention is a fogging-free self-adhesive tape comprising a fogging-free backing to at least one side of which a fogging-free, pressure-sensitive adhesive has been applied.

The adhesive tape of the invention can be provided in fixed lengths such as by the meter, for example, or else as a continuous product on rolls. For use, then, in the latter case it is possible to separate off variable lengths by means of knives, shears or dispensers or the like or else, given an appropriate choice of the materials for the adhesive tapes, to carry out manual processing without tools.

For bonding, use is made in particular of strips of the adhesive tape which have a width of 5 from 15 to 300 mm.

In the text below the intention is to illustrate the invention with reference to a number of figures, without thereby wishing to restrict the invention unnecessarily.

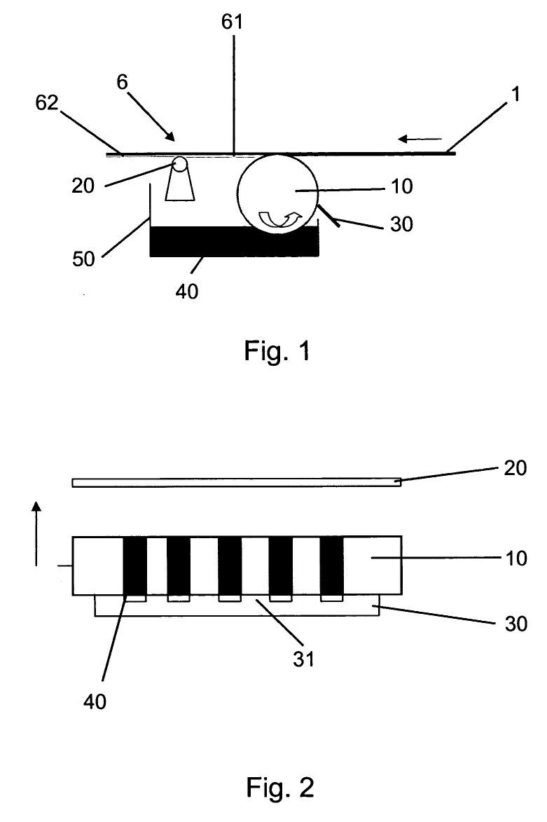

FIG. 1 shows the process of the invention in a side view and FIG. 2 shows the process according to FIG. 1 in plan view.

FIG. 1 depicts a side view of the process of the invention by means of which an adhesive tape 6 with a stripe-shaped application of the adhesive 40 on a backing material can be produced, where

the backing web 1 is guided past a dip roller 10 which is in contact with the backing web 1,

the roll 10 rotates in a bath 50 of adhesive 40, specifically in the running direction of the backing material 1, which is indicated by the arrow, thereby transferring the adhesive 40 to the roll surface,

the roll 10 is designed so that after the roll 10 has run through the bath 50 at least one 20 stripee on the roll surface is adhesive-free.

In the embodiment of the process depicted here there is between bath 50 and backing material 1 on the roll 10 a comb-shaped stripper 30 whose teeth 31 remove the adhesive 40 in stripe form from the surface of the roll 10.

The dip roll 10 runs through the composition 40 and becomes wetted. By means of a stripper 30 with cutouts, located in the 4 o'clock position on the dip roll 10, the composition 40 is stripped off.

Accordingly, at those points where the teeth 31 of the stripper 30 contact the dip roll 10, 30 there is no composition present. When the adhesive 40 is transferred from the dip roll 10 to the material web 1, the material web 1 remains free of adhesive at the same points as the dip roll 10.

Downstream of the roll 10 in the web direction there is a doctor blade 20.

The composition 40 is transferred in excess to the material web 1 by means of the (dip) roll 10. In order to set a pre-defined application rate, a slowly rotating doctor blade 20 strips off the composition 40 down to a defined residual level.

Upstream of the doctor blade 20 the thickness of the layer 61 of adhesive is much greater than after the doctor blade 20. Upstream of the doctor blade 20 the width of the layer 61 of adhesive is much smaller than after the doctor blade 20. After passage through the doctor blade 20 the layer 62 has the desired thickness and width.

FIG. 2 shows the process according to FIG. 1 in plan view, with the backing material 1 having been omitted for clarity. The backing material 1 would run in the direction of the arrow, via the roll 10 and the doctor blade 20.

Clearly evident are the teeth 31 of the stripper 30. The width of the teeth 31 defines the width of the adhesive stripes which are located on the backing material 1. In this case a backing material 1 is produced which carries five stripes of adhesive 40.

1. A process for producing an adhesive tape with a stripe-shaped application of the adhesive on a backing material, where
the backing web is guided past a dip roll which is in contact with the backing web,
the roll rotates in a bath of adhesive, thereby transferring the adhesive to the roll surface,
the roll is designed such that after the roll has run through the bath at least one stripe on the roll surface is adhesive-free.

2. The process as claimed in claim 1, wherein the roll surface is completely smooth or wherein in those areas where no adhesive is to be transferred to the backing material grooves are present or these regions have been rendered dehesive.

3. The process as claimed in claim 1, wherein there is located between bath and backing material downstream of the roll in the direction of rotation a comb-shaped stripper whose teeth remove the adhesive in stripe form from the surface of the roll, the depth and the width of the teeth preferably being adjustable.

4. The process as claimed in claim 1, wherein the roll rotates in the web direction.

5. The process as claimed in claim 1, wherein downstream of the roll in the web direction there is a doctor blade.

6. The process as claimed in claim 5, wherein the doctor blade used is a wire doctor blade, composed of a circular rod around which a wire is wrapped, or of a circular rod without a grooved profile, with a groove profile or with a partly grooved profile.

7. The process as claimed in claim 1, wherein substrates used have a viscosity <2000 mpa*s.

8. An adhesive tape obtained as set forth in claim 1, the adhesive having been applied in the longitudinal direction to at least one side of the backing material of the adhesive tape, in the form of a stripe having a lower width than the backing material of the adhesive tape.

9. The adhesive tape as claimed in claim 8, wherein adhesives having a viscosity <2000 mpa*s are used.
